(19) United States
(12) Patent Application Publication
(10) Pub. No.: US 2015/0346370 A1
(43) Pub. Date: Dec. 3, 2015

(54) METHOD OF CALIBRATION FOR DOWNHOLE FIBER OPTIC DISTRIBUTED ACOUSTIC SENSING

(71) Applicants: Carl S. Martin, Houston, TX (US); Travis S. Hall, Cypress, TX (US); Shane D. Harris, Tomball, TX (US)

(72) Inventors: Carl S. Martin, Houston, TX (US); Travis S. Hall, Cypress, TX (US); Shane D. Harris, Tomball, TX (US)

(73) Assignee: Baker Hughes Incorporated, Houston, TX (US)

(21) Appl. No.: 14/699,661

(22) Filed: Apr. 29, 2015

Related U.S. Application Data
(60) Provisional application No. 62/003,292, filed on May 27, 2014.

(51) Int. Cl. G01V 1/40; G01N 29/24

(52) U.S. Cl. CPC G01V 1/40; G01N 29/2418

(57) ABSTRACT

A method of operating a distributed acoustic sensing (DAS) system and a DAS system are described. The method includes disposing the DAS system to measure acoustic signals in a borehole, positioning a vibration tool at a specified depth in the borehole, and obtaining two or more DAS signals, obtaining at least one of the two or more DAS signals while the vibration tool is activated at a respective specified frequency and a respective specified amplitude. The method also includes calibrating the DAS system based on the two or more DAS signals, and the specified depth, the respective specified frequency, and the respective specified amplitude.

### CROSS-REFERENCE TO RELATED APPLICATION

This application is a Non-Provisional of U.S. Provisional Patent Application Ser. No. 62/003,292 filed May 27, 2014, the disclosure of which is disclosure of which is incorporated by reference herein in its entirety.

### BACKGROUND

In downhole exploration and production efforts, many sensors and measurement systems are used to ascertain information about the downhole environment. Some of these include pressure sensors, temperature sensors, and nuclear magnetic resonance (NMR) sensors used to determine information about a formation, for example. Distributed acoustic sensing (DAS) systems facilitate the identification of downhole events based on changes in vibration or noise, for example.

### SUMMARY

According to an embodiment of the invention, a method of operating a distributed acoustic sensing (DAS) system includes disposing the DAS system to measure acoustic signals in a borehole; positioning a vibration tool at a specified depth in the borehole; obtaining two or more DAS signals, obtaining at least one of the two or more DAS signals while the vibration tool is activated at a respective specified frequency and a respective specified amplitude; and calibrating the DAS system based on the two or more DAS signals, and the specified depth, the respective specified frequency, and the respective specified amplitude.

According to another embodiment, a distributed acoustic sensing (DAS) system includes an optical fiber disposed in a borehole; a light source configured to inject light into the optical fiber; a sensor configured to obtain a DAS signal based on the light; a vibration tool disposed in the borehole at a specified depth, the vibration tool configured to output a vibration signal at one or more specified frequencies and one or more specified amplitudes; and a processor configured to calibrate the DAS system based on two or more DAS signals, at least one of the two or more DAS signals obtained while the vibration tool is activated at a respective specified frequency and a respective specified amplitude, and the specified depth, the respective specified frequency, and the respective specified amplitude.

### BRIEF DESCRIPTION OF THE DRAWINGS

Referring now to the drawings wherein like elements are numbered alike in the several Figures:

FIG. 1 is a cross-sectional view of a borehole including a DAS calibration system according to an embodiment of the invention;

FIG. 2 is a cross-sectional view of a borehole including a DAS calibration system according to another embodiment of the invention;

FIG. 3 details the DAS calibration system shown in FIG. 1 according to one embodiment of the invention;

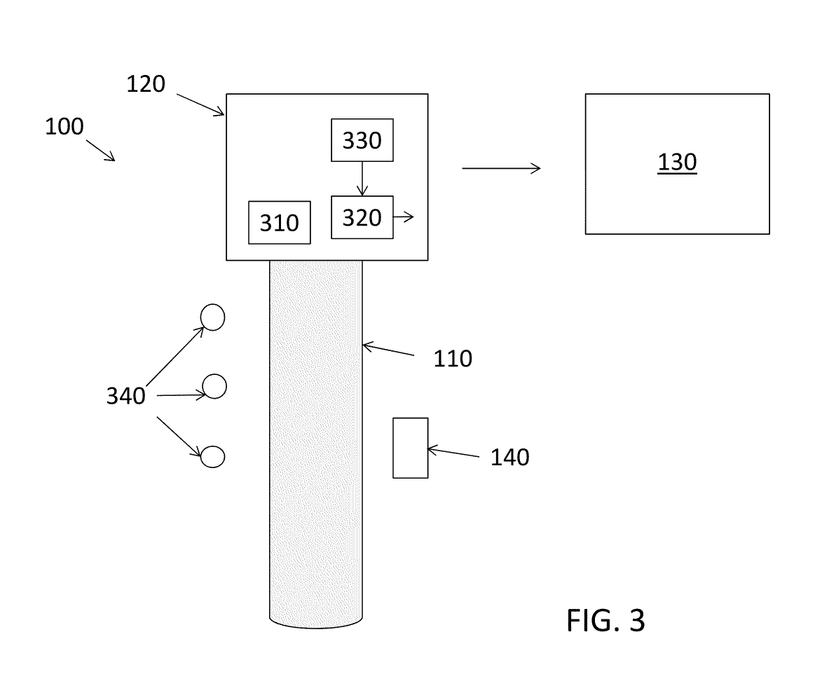

FIG. 4 is a process flow of a method of calibrating a DAS system according to embodiments of the invention; and

FIG. 5 is a process flow of a method of identifying an acoustic event based on a calibrated DAS system according to embodiments of the invention.

### DETAILED DESCRIPTION

As noted above, DAS systems are among the types of sensors used to gather information about a downhole environment. These systems typically involve the use of an optical fiber, light injected into the optical fiber as an interrogation signal, photodetectors that receive light intensity return signals (from Rayleigh backscatter, for example), and a processor that processes the return signals to ascertain the acoustic information. The optical fiber may be longer than only the portion disposed downhole and may be coiled or otherwise deviate from a straight line such that a specific length of the optical fiber does not correspond with a specific depth in the downhole environment. As a result, current DAS systems cannot easily associate a downhole acoustic event with a specific depth. In addition, the response of a DAS system in a test environment may be slightly or drastically different than the response in the downhole environment based on many factors. As a result, current DAS systems indicate relative acoustic levels (such that an occurrence of an event may be recognized) but cannot quantify the acoustic event. Embodiments of the methods and systems discussed herein relate to calibration of a DAS system to facilitate quantified acoustic detection and depth identification.

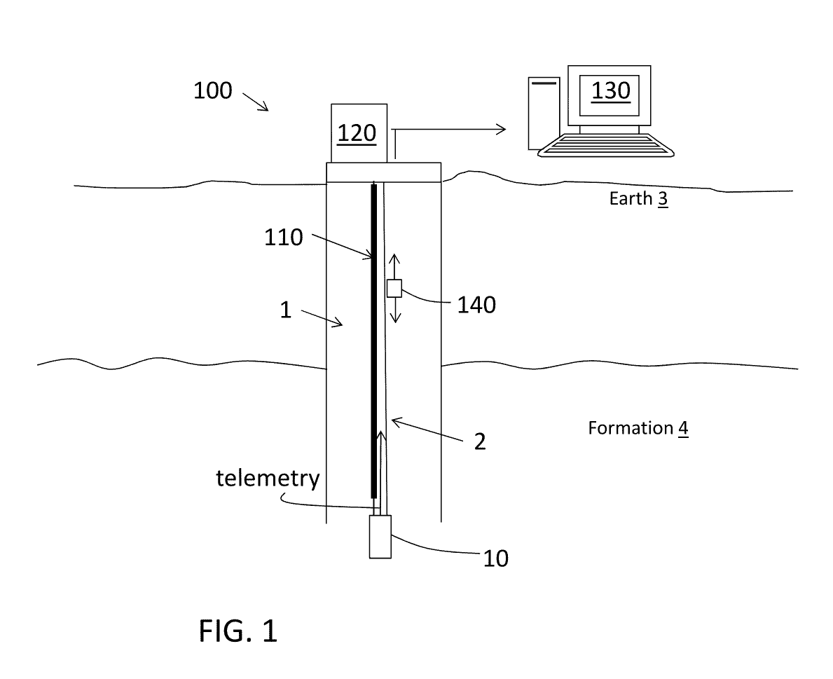

FIG. 1 is a cross-sectional view of a borehole 1 including a DAS system 100 according to an embodiment of the invention. As shown in FIG. 1, the borehole 1 is a completion well, a well ready for production or injection following a drilling process. The DAS system 100 includes an optical fiber 110 and an interrogation unit 120. In the exemplary embodiment shown by FIG. 1, the interrogation unit 120 is on the surface, and the optical fiber 110 is disposed along a carrier 2. The DAS system 100 also includes a calibration component comprising a vibration tool 140 that outputs vibrations at a specified frequency and amplitude. As indicated in FIG. 1, the vibration tool 140 may be moved along the carrier 2 to a specified location within the completion well 1. While the DAS system 100 may be used in other environments and in other sub-surface arrangements, the exemplary DAS system 100 shown in FIG. 1 is arranged to calibrate acoustic levels in the borehole 1 (completion well) penetrating the earth 3 including a formation 4. A set of tools 10 may be lowered into the borehole 1 by a carrier 2. In embodiments of the invention, the carrier 2 is a completion string and may be a casing string, production string, an armored wireline, a slickline, coiled tubing, or a work string. Information from the sensors and measurement devices included in the set of tools 10 may be sent to the surface for processing by the surface processing system 130 via a fiber link or telemetry. The surface processing system 130 (e.g., computing device) includes one or more processors and one or more memory devices in addition to an input interface and an output device.

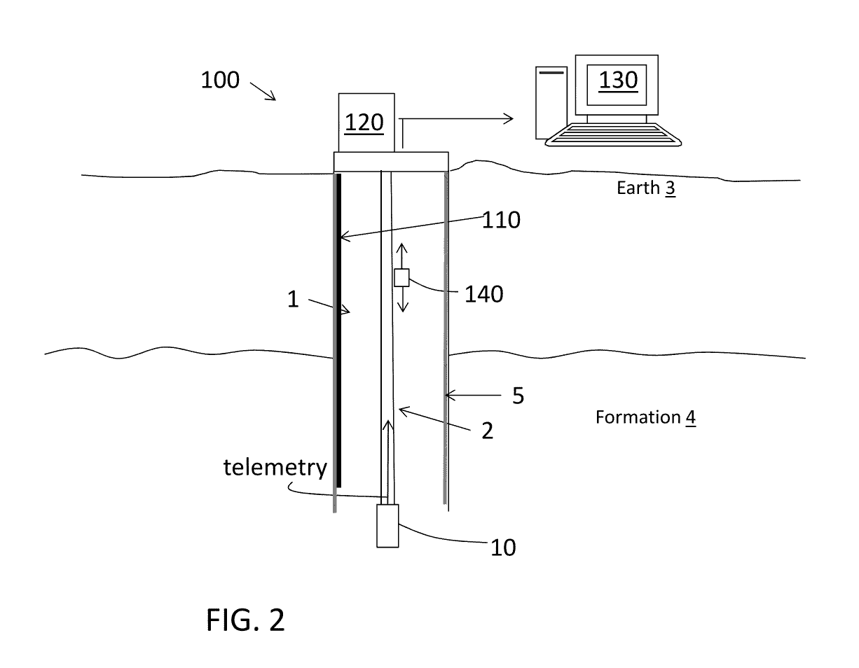

FIG. 2 is a cross-sectional view of a borehole 1 including a DAS system 100 according to another embodiment of the invention. The exemplary embodiment of FIG. 2 shows a cased well that includes casing 5 on the inside of the borehole 1. The optical fiber 110 is shown disposed along the casing 5 in FIG. 2. To be clear, the position of the optical fiber 110 is not limited by the exemplary illustrations. For example, the optical fiber 110 may be disposed along the borehole 1 wall in the open well shown in FIG. 1 or may be disposed along the carrier 2 in the cased well of FIG. 2. In addition, the vibration tool 140 may be disposed in a different location within the borehole 1 (e.g., to move along the casing 5) than the exemplary location shown in FIGS. 1 and 2.

FIG. 2 details the DAS system 100 shown in FIG. 1 according to one embodiment of the invention. The DAS system 100 includes an interrogation unit 120 with a light source 310 and one or more photodetectors 320 to receive the scatter (e.g., Rayleigh backscatter) from the optical fiber 110. The interrogation unit 120 may additionally include a processing system 330 with one or more processors and memory devices to process the scatter resulting from illuminating the optical fiber 110. Alternately, the photodetectors 320 may output the reflection information to the surface processing system 130 for processing. The interrogation unit 120 typically includes additional elements such as a circulator (not shown) to direct light from the light source 310 into the optical fiber 110 and scatter or reflection generated in the optical fiber 110 to the one or more photodetectors 320. Although the one or more photodetectors 220 are shown at the surface as part of the interrogation unit 120 in FIG. 1, other sensors (e.g., geophones 340) may instead be distributed at different depths along the borehole 1 (e.g., along the casing 5 or carrier 2). The specific arrangement of the DAS system 100 is not limited in any way based on the exemplary embodiments discussed herein.

The light source 310 may be a coherent light source in which light waves are in phase with one another. According to one embodiment, the light source 310 may be a laser and may emit pulses of light at the same wavelength and amplitude. According to an alternate embodiment, the light source 310 may be a swept-wavelength laser and may emit pulses of light having a range of wavelengths. The photodetector 320 detects a DAS signal resulting from the incident light pulses being emitted into the optical fiber 110. According to an embodiment of the invention, the DAS signal is a measure of interference among the Rayleigh scatter originating from multiple nearby points in the optical fiber 110 over time (a number of samples of interference signals from a particular length of the optical fiber 110). According to alternate embodiments, the DAS signal may be a measure of interference among scatter resulting from Stokes or anti-Stokes Raman scatter or reflections resulting from or fiber Bragg gratings (FBGs) within the optical fiber 110. The DAS signal is processed to determine the acoustic information.

The DAS signal may be received and processed continuously at a specified interval or may be received and processed based on some trigger. During the calibration process, the vibration tool 140, which is also part of the DAS system 100, is lowered into the borehole 1 to a known depth. The vibration tool 140 may be locked into the carrier 2 at the known depth with slips, a nipple locator, or another type of locking device. The vibration tool 140 may be operated electrically, hydraulically, or by another method such that a known frequency and amplitude are emitted. DAS signals are obtained by the photodetector 320 both with and without the vibration tool 140 being activated or with the vibration tool 140 activated at different amplitudes and frequencies. That is, two or more DAS signals are obtained to perform the calibration. According to one embodiment, a DAS signal is obtained when the vibration tool 140 is not activated and then a two or more DAS signals are obtained after the vibration tool 140 is activated. According to another embodiment, one or more baseline DAS signals are obtained when the vibration tool 140 is activated and then a DAS signal is obtained when the vibration tool 140 is not activated. According to yet another embodiment, two or more DAS signals are obtained when the vibration tool 140 is activated at known amplitude and frequency values. The vibration tool 140 may be moved to one or more other known depths and the process of obtaining DAS signals may be repeated. Based on the DAS signals (with or without vibration tool 140 activation), the acoustic output of the DAS system 100 is calibrated using the known frequency, amplitude, and depth of the vibration tool 140 output. The calibration itself (how the DAS signals and known values are used) is according to one or more known techniques. Once the DAS system 100 is calibrated, the vibration tool 140 may be removed from the borehole 1. As noted above, at this point, the DAS system 100 may be used to detect an acoustic event in the borehole 1. Because of the calibration process, the DAS system 100 is able to quantify the event and also discern the depth of the event.

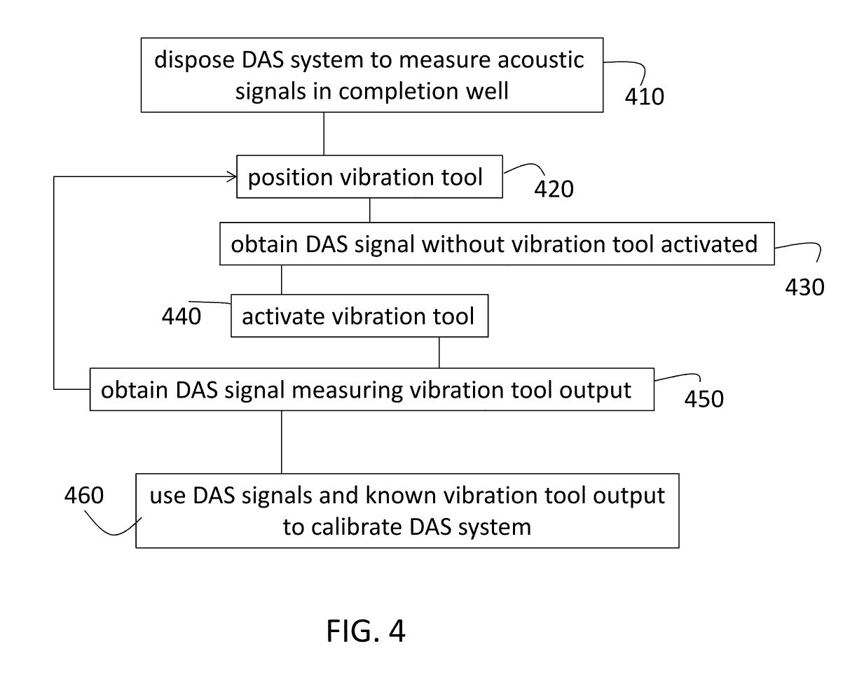

FIG. 4 is a process flow of a method of calibrating a DAS system 100 according to embodiments of the invention. At block 410, disposing the DAS system 100 to measure acoustic signals in the borehole 1 may be as shown in FIG. 1, for example. Positioning the vibration tool 140 at block 420 includes moving the vibration tool 140 to different depths in the borehole 1. This may be done by moving the vibration tool 140 along the carrier 2 or casing 5 and locking the vibration tool 140 in place at a specified depth. At block 430, obtaining a DAS signal includes the DAS system 100 receiving interference signals based on Rayleigh scatter, for example, while the vibration tool 140 is not activated. At block 440, activating the vibration tool includes emitting a signal with a specified frequency and amplitude. At block 450, obtaining the DAS signal measuring vibration tool 140 output includes receiving interference signals based on Rayleigh scatter, for example, while the vibration tool 140 is activated. According to an alternate embodiment, a DAS signal may not be obtained while the vibration tool 140 is not activated (at block 430). Instead, two or more DAS signals may be obtained with the vibration tool 140 being activated at two or more different amplitude or frequency values (at block 450), as noted above. According to another alternate embodiment, one or more DAS signals may be obtained with the vibration tool 140 activated (at block 450) and then a DAS signal may be obtained with the vibration tool 140 being deactivated. At block 460, using the DAS signals (obtained at blocks 430, 450, or both) and the known vibration tool 140 output to calibrate the DAS system 100 facilitates determination of quantitative acoustic level and depth of origin of an acoustic event. As indicated in FIG. 4, blocks 420 through 450 may be repeated. That is, DAS signals may be obtained with the vibration tool 140 located at different depths. The number of depths at which the vibration tool 140 is operated may improve the resolution of the DAS system 100 calibration.

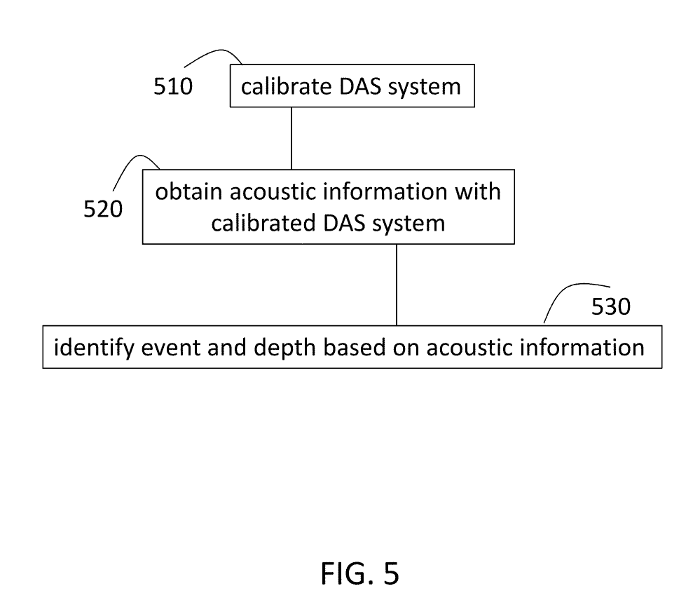

FIG. 5 is a process flow of a method of identifying an acoustic event based on a calibrated DAS system 100 according to embodiments of the invention. At block 510, calibrating the DAS system 100 is as discussed above. Obtaining acoustic information with the calibrated DAS system 100 at block 520 may include removing the vibration tool 140 from the borehole 1 and obtaining and processing DAS signals periodically or based on a trigger. Because of the calibration, the acoustic information obtained from the DAS signals is quantified (a specific vibrational force is identified, for example) and a depth of the origin of the acoustic information is obtained. Identifying an event (cause of the acoustic information) and a depth based on the acoustic information, at block 530, may be according to a database of known acoustic events, for example. That is, a specific range of amplitudes may be associated with breach of water flow into the borehole 1, for example. Thus, a lookup table may be implemented to identify the cause of an acoustic event, for example.

While one or more embodiments have been shown and described, modifications and substitutions may be made thereto without departing from the spirit and scope of the invention. Accordingly, it is to be understood that the present invention has been described by way of illustrations and not limitation.

1. A method of operating a distributed acoustic sensing (DAS) system, the method comprising:
disposing the DAS system to measure acoustic signals in a borehole;
positioning a vibration tool at a specified depth in the borehole;
obtaining two or more DAS signals, obtaining at least one of the two or more DAS signals while the vibration tool is activated at a respective specified frequency and a respective specified amplitude; and
calibrating the DAS system based on the two or more DAS signals, and the specified depth, the respective specified frequency, and the respective specified amplitude.

2. The method according to claim 1, wherein the disposing the DAS system includes disposing an optical fiber in the borehole, disposing a light source to inject light into the optical fiber, and disposing one or more photodetectors, the one or more photodetectors detecting interference resulting from the light in the optical fiber.

3. The method according to claim 2, wherein the detecting interference includes detecting interference among Rayleigh scatter originating at two or more points along the optical fiber.

4. The method according to claim 3, further comprising processing the interference to obtain a DAS signal and obtaining acoustic information based on the DAS signal.

5. The method according to claim 2, wherein the disposing the light source and the disposing the one or more photodetectors is at a surface location.

6. The method according to claim 1, wherein the obtaining the two or more DAS signals includes obtaining at least one of the two or more DAS signals while the vibration tool is inactive.

7. The method according to claim 1, further comprising disposing two or more geophones at different locations within the borehole to obtain the baseline DAS signal and the calibration DAS signal.

8. The method according to claim 1, wherein the positing the vibration tool includes affixing the vibration tool to a carrier disposed in the borehole at the specified depth.

9. The method according to claim 1, further comprising removing the vibration tool from the completion well following the calibrating.

10. The method according to claim 1, further comprising quantifying an acoustic event and determining a depth of the acoustic event based on obtaining a post-calibration DAS signal after the calibrating.

11. The method according to claim 10, further comprising identifying a cause of the acoustic event based on the quantifying and a lookup table.

12. A distributed acoustic sensing (DAS) system, comprising:
an optical fiber disposed in a borehole;
a light source configured to inject light into the optical fiber;
a sensor configured to obtain a DAS signal based on the light;
a vibration tool disposed in the borehole at a specified depth, the vibration tool configured to output a vibration signal at one or more specified frequencies and one or more specified amplitudes; and
a processor configured to calibrate the DAS system based on two or more DAS signals, at least one of the two or more DAS signals obtained while the vibration tool is activated at a respective specified frequency and a respective specified amplitude, and the specified depth, the respective specified frequency, and the respective specified amplitude.

13. The system according to claim 12, wherein the sensor is a photodetector configured to obtain the DAS signal based on detecting interference among Rayleigh scatter originating at two or more points along the optical fiber.

14. The system according to claim 13, wherein the processor processes the interference to obtain the DAS signal and processes the DAS signal to obtain acoustic information.

15. The system according to claim 12, wherein the sensor is disposed at a surface location.

16. The system according to clam 12, wherein the sensor includes two or more geophones disposed at different locations within the borehole.

17. The system according to claim 12, wherein the vibration tool is affixed to a carrier disposed in the borehole at the specified depth.

18. The system according to claim 17, wherein the optical fiber is disposed along the carrier or along a cased or uncased wall of the borehole.

19. The system according to claim 12, wherein the processor is further configured to quantify an acoustic event and determine a depth of the acoustic event based on a post-calibration DAS signal obtained after the processor calibrates the DAS system.

20. The system according to claim 19, wherein the processor is further configured to identify a cause of the acoustic event based on quantifying the acoustic event and on a lookup table.
